(19) United States
(12) Patent Application Publication
(10) Pub. No.: US 2004/0102101 A1
(43) Pub. Date: May 27, 2004

(54) Subassembly with a plug-in housing connector

(76) Inventor: Ulf Scheuerer, Hagelstadt (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/343,079

(22) PCT Filed: Jun. 27, 2001
(86) PCT No.: PCT/DE01/02372

(30) Foreign Application Priority Data
Jul. 25, 2000 (DE) 10036138.2

(51) Int. Cl. H01R 13/10

(52) U.S. Cl. 439/682

(57) ABSTRACT

A subassembly for installing in a housing (2) comprises a supporting plate (4) on which a plug-in connector (5) is mounted as a separate part. Said plug-in connector (5) of the plug-in extends through a connector opening in the housing. A base section (5a) of the plug-in connector (5) is introduced into a receptacle of the supporting plate (13), which allows for the movement play of the plug-in connector (5) in the plane of the supporting plate (4) that is required for installation.

The invention relates to a subassembly for installing in a housing, in particular the transmission or engine housing, of a motor vehicle, which subassembly comprises a supporting plate and a plug-in connector designed as a separate part and mounted on the supporting plate, the plug-in connector being intended for protruding through a connector opening in the housing in the installed state.

While previously electronic controllers located in the passenger compartment of the motor vehicle were used for engine and transmission control purposes, there is currently a trend toward integration of the control electronics and the associated sensor technology in the corresponding subassembly (i.e. engine or transmission). The advantages of such fully integrated engine or transmission control are increased reliability and lower costs.

To lead electrical signals out of the transmission or engine housing to the outside, oil-tight plug-in connectors are used. To ensure that the plug-in connector can be mounted and sealed in a connector opening in the housing, suitable measures must be taken to compensate for installation tolerances in order to make the connector flexible. On the other hand, it must be noted that the plug-in connector in the installed state has to meet demanding requirements in terms of vibration resistance and long-term leak-tightness under difficult ambient conditions (vibrations up to about 33 g, temperature changing in the range from −40° to 140° C., ATF oil as ambient medium).

A plug-in transmission connector on which the contact pins in the base region are mounted on a leadframe carried in the supporting plate is already known. By suitable design of the leadframe and tiltable articulation of the connector base on the supporting body, the connector can be flexibly aligned within a specific tolerance range. The difficulties of this solution are the relatively great space requirement (a certain minimum distance must be maintained between the supporting plate and the housing) and the risk of material fatigue occurring in the region of the connections between the contact pins and the leadframe.

Another known possibility is to provide a rigid connection between the plug-in connector and the supporting body and to achieve the required tolerance compensation by a thick sealing O-ring, which is pushed onto the plug-in connector. This solution is not suitable to compensate for large tolerances and, moreover, does not allow optimum mechanical relief of the plug-in connector in the transitional region with respect to the supporting plate.

European patent application EP 0 908 974 A2 discloses a plug-in transmission connector which is mounted on the supporting plate by means of an intermediate element. The intermediate element has a sliding rail, in which the plug-in transmission connector is displaceable in a given direction parallel to the supporting plate. However, the displaceability of the plug-in transmission connector does not allow tolerance compensation, since the displacement takes place coaxially with respect to the axis of the connector opening.

The invention is based on the object of providing a subassembly of the type stated at the beginning which makes it possible to make the plug-in connector flexible with respect to the supporting plate at low cost. In particular, the structural design provided for this purpose is intended to have a low space requirement.

The object on which the invention is based is achieved by the features of claim 1.

The provision of a receptacle in the supporting plate, in which a base section of the plug-in connector is inserted with lateral play, achieves the effect that the plug-in connector can be aligned with respect to the connector opening entirely free from any loads during the installing of the subassembly in the housing. The gap width between an outer circumference of the base section of the plug-in connector and the inner circumference of the receptacle may in this case be dimensioned in such a way that no bending stresses occur on the plug-in connector, even when there are large installation tolerances.

Preferably provided as a further measure is a damping ring which is arranged on the plug-in connector in the installed state between a resting surface on the base section of the plug-in connector and the housing and is forced into place. The damping ring aligns the plug-in connector with the plug-in opening during installation of the subassembly and fixes it in the installed position.

A preferred configuration of the subassembly according to the invention is characterized in that, at the height of the supporting plate surface facing the connector opening, engagement sections of a complementary form are provided on the receptacle and connector base. The engagement sections on the connector base and on the supporting plate form resting surfaces for the damping ring. In addition, rotational securement of the plug-in connector in the supporting plate is realized by the engagement sections. Should rotational stressing of the plug-in connector occur during the installation of the subassembly or during operation of the vehicle, the rotational securement ensures that the forces occurring are absorbed with minimal twisting of the plug-in connector and therefore do not act on the electrical leads (for example flexible printed circuit board).

In the case of a particularly low-cost configurational variant of the invention, the plug-in connector is electrically contacted by means of a flexible printed circuit board mounted on the bottom of the plug-in connector base. The electrical printed circuit board may in this case be designed as an integral connecting element for the distribution of electrical signals in the entire transmission or engine.

According to a preferred development of the invention, an integral section of the supporting plate is designed as a housing cover for an electrical control device, and the flexible printed circuit board extends on the underside of the supporting plate to the control device and electrically contacts the control electronics accommodated in the control device.

Further advantageous refinements of the invention are specified in the subclaims.

The invention is explained below on the basis of an exemplary embodiment with reference to the drawing, in which:

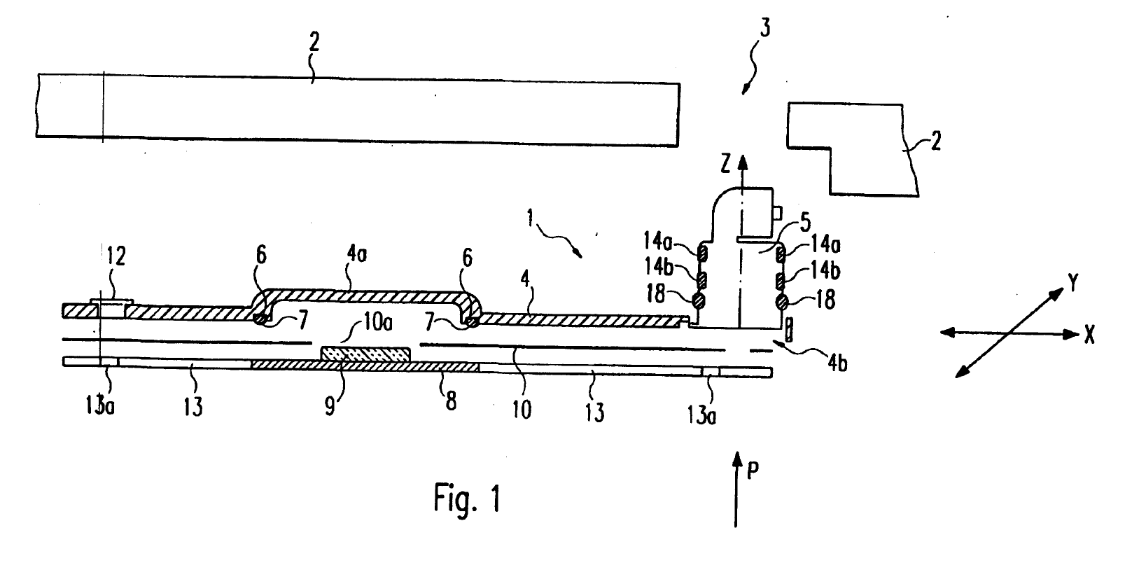

FIG. 1 shows a schematic sectional representation of the subassembly according to the invention, comprising a supporting plate and plug-in connector mounted thereon and also further parts for installation in a transmission;

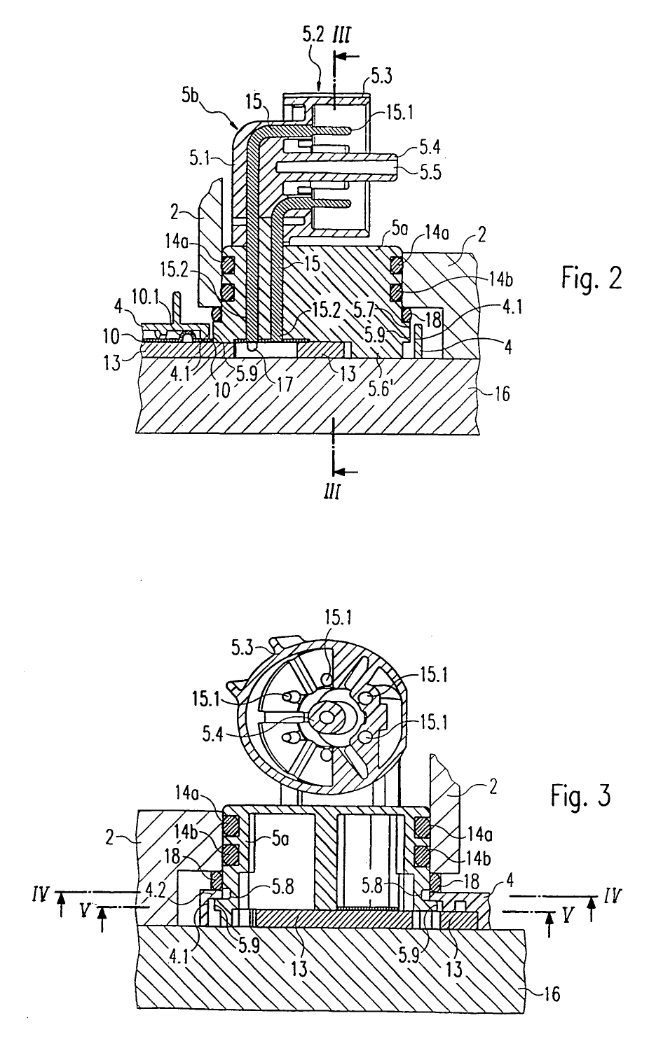

FIG. 2 shows a schematic sectional representation of the supporting plate and plug-in connector in the installed state;

FIG. 3 shows an oblique view, cut open along the line I-I, of the arrangement represented in FIG. 2;

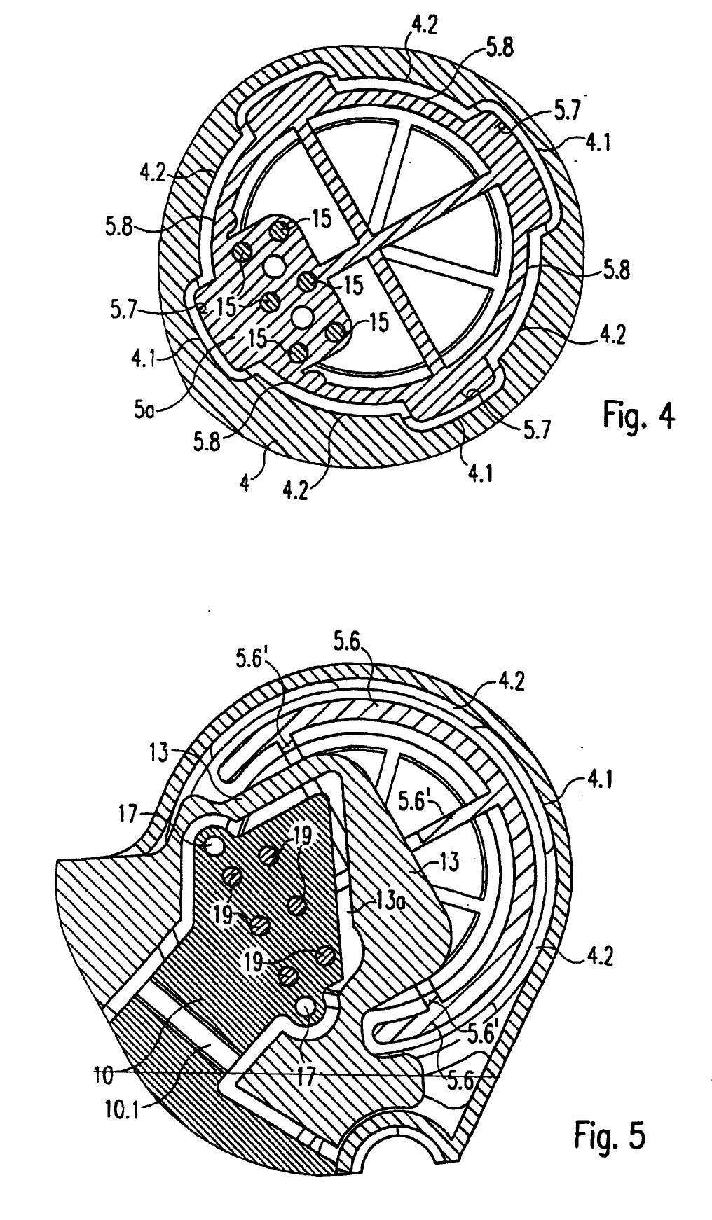

FIG. 4 shows a schematic sectional representation along the line II-II in FIG. 3; and

FIG. 5 shows a schematic sectional representation along the line III-III in FIG. 3.

FIG. 1 shows an exemplary embodiment of a subassembly 1 according to the invention for installing in a motor vehicle transmission. A subsection of the transmission housing 2 with a connector opening 3 can be seen in the upper part of FIG. 1. The subassembly 1 comprises a plastic supporting plate 4 and a plug-in connector 5. In an integral section of the plastic supporting plate 4, a hood-shaped cover 4a for an electronic transmission control device is formed. The cover 4a has a peripheral sealing groove 6, which has been made in the surface of the plastic supporting plate 4 facing away from the transmission housing 2. A form seal 7 has been inserted into the peripheral sealing groove 6.

An aluminum plate 8 forms the base plate of the transmission control device. The aluminum plate 8 serves as a heat sink of an electronic circuit, which is realized for example on a ceramic substrate 9 mounted on the aluminum plate 8.

The electrical contacting of the electronic circuit takes place by means of a flexible printed circuit board 10. The flexible printed circuit board 10 has a central clearance 10a, through which the ceramic substrate 9 protrudes in the assembled state. The flexible printed circuit board 10 extends in the lateral direction to sensors and actuators, which are located outside the transmission control device and, if appropriate, may be mounted in the plastic supporting plate 4, see for example a temperature sensor designated by reference numeral 12. The flexible printed circuit board 10 extends further to the plug-in connector 5.

The assembly of the unit comprising the transmission control device and the plug-in connector 5 takes place as follows:

Firstly, the flexible printed circuit board 10 is laminated in an oil-tight manner onto the surface of the aluminum plate 8. After that, the ceramic substrate 9 with the electronic circuit is fastened on the aluminum plate 8 and electrically connected by bonding wires or other suitable contacting elements to the flexible printed circuit board 10.

In a further working step, the temperature sensor 12 is inserted into the plastic supporting plate 4 and the plug-in connector 5 is pushed from below (in the direction of the arrow P) into a receiving opening 4b of the plastic supporting plate 4, so that it is located in the position represented in FIG. 1. The plug-in connector 5 has a longitudinal axis Z, which runs substantially perpendicularly in relation to the plane XY of the supporting plate.

In a next step, the aluminum plate 8 is placed with the electronic circuit mounted on it and the flexible printed circuit 10 onto the plastic supporting plate 4. An inner space of the transmission control device defined by the aluminum plate 8 and the cover 4a is sealed against oil penetration by the form seal 7. The flexible printed circuit board 10 is at the same time led through between the form seal 7 and the aluminum plate 8.

The aluminum plate 8 may be continued in the lateral direction by an optional flexible support element 13 adjoining flush with the aluminum plate 8. The flexible support element 13 serves for supporting and prescribing a defined path of the flexible printed circuit board 10 outside the aluminum plate 8 and secures the plug-in connector 5 against falling out in the direction counter to the arrow P.

Following that, the temperature sensor 12 and the plug-in connector 5 are electrically connected to the flexible printed circuit board 10. The abutting contacting takes place, for example, by means of a laser welding process. For this purpose, the flexible support element 13 has at the corresponding points apertures 13a, through which the laser radiation can be directed onto the underside of the flexible printed circuit board.

After the contacting step, the entire assembly is inserted into the transmission as part of the installation of the transmission. On account of the construction of the subassembly according to the invention, explained in still more detail below, it is possible to compensate for installation tolerances by displacement of the plug-in connector 5 in the receiving opening 4b of the plastic supporting plate. In the installed state, the plastic supporting plate 4 and the wall 2 of the transmission housing in the region of the connector opening 3 run parallel to each other and the plug-in connector 5 protrudes through the connector opening 3. The sealing between the plug-in connector 5 and the connector opening 3 is achieved by two sealing rings 14a, 14b seated on the connector body.

Furthermore, mounted on the plug-in connector 5 in the region above the supporting plate 4 is a damping ring 18, which clamps the plug-in connector 5 with respect to the transmission housing after installation in the transmission. The damping ring 18 has the effect of fixing and positionally damping the plug-in connector 5 in the installed state.

FIG. 2 shows a sectional representation of the plug-in connector 5 in the installed position. The plug-in connector 5, consisting of plastic, comprises a connector base 5a and a connector head 5b, attached to the connector base. The connector head 5b has in the embodiment represented a neck section 5.1 with a 90° bend and an adjoining plug-in section 5.2. The plug-in section 5.2 is formed by a cylindrical connector housing 5.3, in the center of which a central stub 5.4 protruding beyond the connector housing 5.3 is arranged, see also FIG. 3. The central stub 5.4 is provided with a tapering centering channel 5.5, which interacts with a correspondingly arranged pin of a connector socket (not represented). Another possibility is for the plug-in connector 5 to be configured on a single axis, i.e. without a 90° bend in the neck section 5.1.

It goes without saying that, in an alternative way, the male plug-in section 5.2 may also be configured as a female socket, which interacts with an external male plug-in part not represented.

Connector base 5a and connector head 5b are passed through by electrical conductors 15. The electrical conductors are formed in the region of the connector housing 5.3 as protruding contact pins 15.1. With their other ends 15.2, the electrical conductors 15 lie freely on the bottom of the connector base 5a and are contacted there by conductor tracks of the flexible printed circuit board 10.

The attachment of the connector base 5a on the plastic supporting plate 4 is explained in more detail below on the basis of FIGS. 2 and 3.

In the installed state, the entire assembly comprising the flexible support plate 13, the flexible printed circuit board 10 and the subassembly according to the invention (plastic supporting plate 4 with plug-in connector 5) is located on a hydraulic control plate 16 of the transmission. The hydraulic control plate 16 runs parallel to and at a small distance from the wall 2 of the transmission housing.

The connector base 5a is supported by a part-circular annular foot 5.6, which is provided with radial webs 5.6′ (see also FIG. 5), on the hydraulic control plate 16. The remaining region of the bottom of the connector base is set back from the annular foot 5.6, so that in this region there is an intermediate space between the hydraulic control plate 16 and the bottom of the connector base 5a. The flexible support element 13 and the flexible printed circuit board 10 arranged on it are located in this intermediate space. It is pointed out that the flexible printed circuit board 10 is not fixed on the flexible support element 13, at least in the vicinity of the contact points with respect to the conductor ends 15.2, but is freely movable with respect to said element. Mechanical fixing of the flexible printed circuit board 10 takes place on the one hand on the bottom of the conductor base 5a as a result of the abutting contacting with the conductor ends 15.2 (pins 17 which protrude through bores in the flexible printed circuit board 10 being provided for the tension relief of the contact points on the bottom of the connector) and on the other hand at a location which is far enough away from the plug-in connector 5 to ensure free displaceability of the flexible printed circuit board 10 in the region of the connector. In addition, a reserve of printed circuit board material may be kept in the form of a circuit board corrugation 10.1 for the purposes of tension relief.

The receiving opening 4b of the supporting plate 4 is dimensioned in such a way that there is a circumferentially continuous gap between the rim 4.1 of the opening and an outer circumference of the connector base 5a (in FIG. 2, a lower region 5.9 and a section 5.7 lying above it of this outer circumference can be seen). The gap width may be approximately between 0.5 mm and 2 mm, whereby a path of movement of 1 mm to 4 mm is realized in all directions of the XY plane.

As can be seen in FIG. 3, the outer circumference of the connector base 5a also has in the upper subregion at the height of the section 5.7 circumferential depressions 5.8.

FIG. 4 shows a section through the connector base 5a and the plastic supporting plate 4 at the height of the circumferential section 5.7 and the circumferential depressions 5.8 along the line II-II in FIG. 3. Distributed over the circumference, four circumferential depressions 5.8 are provided. The circumferential segments remaining between the circumferential depressions 5.8 are bordered by the circumferential sections 5.7. Protruding into the circumferential depressions 5.8 are projections 4.2 of a complementary design of the plastic supporting plate 4, which are realized on corresponding sections at the rim of the receiving opening 4b, see also FIG. 3.

It becomes clear from FIGS. 2 and 3 in conjunction with FIG. 4 that the damping ring 18 rests in certain regions on the surfaces of the circumferential sections 5.7 and the surfaces of the projections 4.2 of the plastic supporting plate 4. On account of the contact pressure exerted by the damping ring 18 on both parts (connector base 5a and plastic supporting plate 4), a high mechanical positional stability of the plug-in connector 5 is achieved in the installed state.

The circumferential depressions 5.8 of the connector base 5a also form with the projections 4.2 of the supporting plate 4 a rotational securement. In order not to impair the free mobility of the plug-in connector 5 in the receiving opening 4b of the supporting plate 4 within the degree of tolerance during installation, the gap continues with a substantially constant gap width over the entire circumference between the sections 4.2 and 5.8 or 4.1 and 5.7 and in particular also in the region of the transitions between the sections mentioned.

In the region underneath the circumferential depressions 5.8 and the circumferential sections 5.7, the outer circumference 5.9 of the connector base 5a is of a circular design. This lower, annular region of the connector base 5a reaches under the projections 4.2 of the supporting plate 4 and secures the plug-in connector 5 against falling out in the direction of the arrow P.

FIG. 5 shows a section through the subassembly according to the invention at the height of the flexible printed circuit board 10 along the line III-III in FIG. 3. Of the plastic supporting plate 4, the opening rim 4.1 can be seen; in the region of the connector base 5a, the section passes through the part-circular annular foot 5.6 and through radial webs 5.6′. The two outer radial webs 5.6′ are designed merely in the form of short stubs. The flexible support element 13 extends through the lateral opening of the part-circular annular foot 5.6, under the connector base 5a. As already described, the flexible support element 13 is provided in the region of the conductor ends 15.2 with a clearance 13a, through which the underside of the flexible printed circuit board 10 can be seen. The contact points between the conductor ends 15.2 of the plug-in connector 5 and conductor tracks (not represented) of the flexible printed circuit board 10 are identified by the reference numeral 19. They may be produced, for example, by a laser welding step. Furthermore, the pins 17 protruding through openings in the flexible printed circuit board 10 can be seen.

It becomes clear from the exemplary embodiment described above that the invention allows movement play of the plug-in connector 5 in the XY plane defined by the supporting plate 4 on all sides before and during the installation of the subassembly 1. At the same time, extremely small installation depths of approximately 1 cm can be realized between the surface of the hydraulic control plate 16 and the inner side of the housing wall 2, and nevertheless no bending stresses occur during the installation of the subassembly in the region of the coupling between the plastic supporting plate 4 and the plug-in connector 5.

1. A subassembly for installing in a housing, which subassembly comprises a supporting plate (4) and a plug-in connector (5) designed as a separate part and mounted on the supporting plate (4), the plug-in connector (5) protruding through a connector opening (3) in the housing (2) in the installed state, characterized
in that a longitudinal axis Z of the plug-in connector (5), running parallel to the axis of the connector opening (3) in the housing, is oriented substantially perpendicularly in relation to a plane XY of the supporting plate, and
in that a base section (5a) of the plug-in connector (5) is inserted in a receptacle (4b) of the supporting plate (4) which allows movement play of the plug-in connector (5) in the XY plane.

2. The subassembly as claimed in claim 1, characterized
in that, in the mid-centered state between an inner circumference (4.1; 4.2) of the receptacle (4b) and an outer circumference (5.7, 5.8; 5,9) of the base section (5a), there extends a gap of substantially constant gap width.

3. The subassembly as claimed in one of the preceding claims, characterized
in that the gap width is between 0.5 and 2.0 mm.

4. The subassembly as claimed in one of the preceding claims, characterized by
a damping ring (18), which is arranged on the plug-in connector (5) in the installed state between a resting surface on the base section (5a) of the plug-in connector (5) and the housing (2).

5. The subassembly as claimed in one of the preceding claims, characterized
in that provided on the receptacle (4b) and on the connector section (5a) of the plug-in connector (5) are engagement sections (5.8, 4.2) of a complementary form, distributed over the circumference.

6. The subassembly as claimed in claims 4 and 5, characterized
in that surfaces of the engagement sections (5.8, 4.2) of a complementary form facing the connector opening (3) form resting surfaces for the damping ring (18).

7. The subassembly as claimed in one of the preceding claims, characterized
in that the plug-in connector (5) is electrically contacted by means of a flexible printed circuit board (10) mounted on the bottom of the base section (5a).

8. The subassembly as claimed in claim 7, characterized
in that an integral section of the supporting plate (4) forms a housing cover (4a) for an electrical control device and
in that the flexible printed circuit board (10) extends on the underside of the supporting plate (4) to the control device and electrically contacts the latter.

9. The subassembly as claimed in one of the preceding claims, characterized
in that the housing (2) is a transmission or engine housing of a motor vehicle.
